(19) United States
(12) Patent Application Publication
(10) Pub. No.: US 2023/0243406 A1
(43) Pub. Date: Aug. 3, 2023

(54) TRANSMISSION ASSEMBLY WITH TORQUE CONVERTER COVER TO HUB CONNECTOR USING EXTRUDED STUDS

(71) Applicant: Schaeffler Technologies AG & Co. KG, Herzogenaurach (DE)

(72) Inventor: Drew HILTY, Wooster, OH (US)

(73) Assignee: Schaeffler Technologies AG & Co. KG, Herzogenaurach (DE)

(21) Appl. No.: 17/587,522

(22) Filed: Jan. 28, 2022

(51) Int. Cl. F16H 45/02; F16H 61/14

(52) U.S. Cl. CPC F16H 45/02; F16H 61/143; F16H 2045/0278

(57) ABSTRACT

A transmission assembly and a method of assembling a transmission assembly that is located between the engine block and the transmission gearbox is provided. The assembly includes a hub having a fluid path for a clutch and a hub flange, a torque converter cover formed with extruded studs in an area adapted to be connected to the hub flange, the extruded studs including a circumferential outer surface having a plurality of serrations, holes in the hub flange in locations corresponding to locations of the extruded studs, with a respective inside diameter of each of the holes being smaller than an outside diameter of the studs; and the hub being connected to the torque converter cover with the studs engaging in the holes in the hub flange with an interference fit.

### FIELD OF INVENTION

The disclosure relates to a transmission that includes an improved construction arrangement and assembly method for the torque converter to hub connection.

### BACKGROUND

In a P1 hybrid architecture, an electric motor (emotor) is integrated into the drivetrain with the rotor directly engaged with the crankshaft of the internal combustion engine (ICE), and torque from the emotor and/or the ICE is transmitted via a transmission assembly that includes the torque converter to the transmission gear box.

In one known arrangement of the transmission assembly that is located between the end of the crankshaft and the transmission gear box, fluid is directed via a hub that is riveted to the torque converter cover to a lock-up clutch actuator. FIG. 1 shows a half cross-section of this prior art arrangement. The engine is schematically indicated at ICE, the transmission gearbox is schematically indicated as XMSN, and emotor is indicated as EM. Here the riveted connection in the transmission assembly uses upset rivets 2 to axially and rotationally fix the hub 3 to the torque converter cover 4 of a torque converter 5. However, here there is the high risk of damaging or cracking the hub 3 during the riveting process. Further, extruding the rivet post from the torque converter cover 4 to the height required for upset riveting has proved challenging due to the thickness of the hub needed when lightweight materials are considered.

. It would be desirable to find a cost-effective solution to these issues that improves quality without increasing costs, weight or assembly time.

### SUMMARY

In one aspect, a method of assembling a transmission assembly is disclosed that includes (a) providing a hub having a fluid path for a clutch and a hub flange; (b) forming a torque converter cover of a torque converter with extruded studs in an area adapted to be connected to the hub flange, the extruded studs including a circumferential outer surface having a plurality of serrations; (c) forming holes in the hub flange in locations corresponding to locations of the extruded studs, a respective inside diameter of each of the holes being smaller than an outside diameter of the studs; and (d) pressing the hub onto the torque converter cover with the studs engaging in the holes in the hub flange with an interference fit.

In one arrangement, the extruded studs have a height that is approximately equal to a thickness of the hub flange.

The method can further include installing an actuator piston and a lock-up clutch inside the torque converter cover, as well as installing a torque converter turbine and a damper connected to the torque converter turbine inside the torque converter cover, and a transmission output hub connected to the torque converter turbine.

In the disclosed arrangement, the output hub holds the hub axially against the torque converter cover in an assembled state. Here the only loading on the hub is an axial thrust load, which allows the hub to be made of a lightweight material, such as powdered metal or aluminum.

In another aspect, a transmission assembly that is configured to be located between an end of a crankshaft and a transmission gear box is disclosed. Here, the transmission assembly includes a hub having a fluid path for a clutch and a hub flange as well as a torque converter having a torque converter cover. Extruded studs are formed on the torque converter cover, preferably as part of the stamping process, and are located in an area adapted to be connected to the hub flange. The extruded studs include a circumferential outer surface having a plurality of serrations. The hub flange including holes defined in locations corresponding to locations of the extruded studs, and a respective inside diameter of each of the holes is smaller than an outside diameter of the studs. The hub is assembled to the torque converter cover via the studs engaging in the holes in the hub flange with an interference fit.

This arrangement avoids the need for upset riveting, which is prone to damaging parts made of lightweight materials, such as powdered metal or aluminum. Accordingly, the present arrangement allows for the use of these lightweight materials.

In one aspect, the extruded studs have a height that is approximately equal to a thickness of the hub flange.

In another aspect, the transmission assembly further includes an actuator piston and a lock-up clutch inside the torque converter cover, and can further include a damper connected to a torque converter turbine of the torque converter, and a transmission output hub connected to the torque converter turbine.

According to the present disclosure, the output hub is configured to hold the hub axially against the torque converter cover. As no circumferential loads are introduced into the hub, lightweight materials can be used that are sufficient to carry the axial thrust loads that are present.

For further weight savings, the hub flange is segmented, and one of the holes is located in each flange segment.

Various features of the invention can be used alone or in combination in order to achieve one or more of the benefits described herein.

### BRIEF DESCRIPTION OF THE DRAWINGS

The foregoing Summary and the following detailed description will be better understood when read in conjunction with the appended drawings, which illustrate preferred embodiments according to the disclosure. In the drawings:

FIG. 1 is a cross-sectional view, in half-section, of a prior art transmission assembly that is located between the end of the crankshaft from the engine block and the transmission gear box.

FIG. 2 is a detailed view of a portion of a torque converter cover including an extruded stud in accordance with the present disclosure.

FIG. 3 is a perspective view showing a hub used in a transmission assembly according to the present disclosure.

FIG. 4 is a perspective view, partially in cross-section, showing a portion of the transmission assembly in accordance with the present disclosure using the torque converter cover shown in FIG. 2 and the hub shown in FIG. 3.

FIG. 5 is a flow chart showing a method of assembling a transmission assembly.

### DETAILED DESCRIPTION

Certain terminology is used in the following description for convenience only and is not limiting. The words “inwardly” and “outwardly” refer to directions toward and away from the parts referenced in the drawings. “Axially” refers to a direction along the axis of a shaft. “Radially” refers to a direction normal to an axis. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terms “about” and “approximately” encompass + or - 10% of an indicated value unless otherwise noted. The terminology includes the words specifically noted above, derivatives thereof and words of similar import.

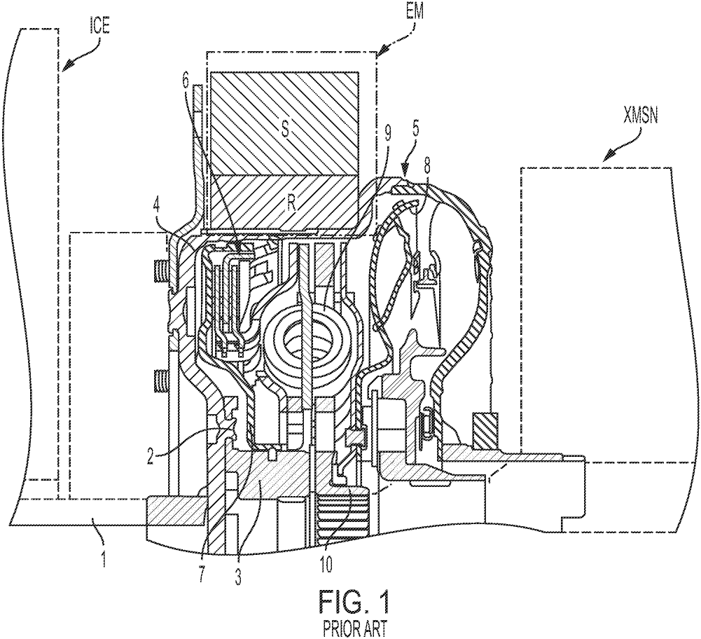

Referring to FIG. 1, a half-cross section through a transmission assembly that is adapted to be arranged between the ICE block and a further transmission gear box XMSN as shown. This is used in connection with a P1 hybrid architecture in which the emotor EM is integrated directly with the block with the rotor being attached to the crankshaft 1 for co-joint rotation therewith. The transmission assembly includes the torque converter 5 formed with a torque converter cover 4 as well as a torque converter turbine 8 located inside the cover 4 and adapted to transfer torque via a fluid connection between the torque converter cover 4 and the turbine 8. Within the torque converter cover 4 is a hub 3 that is connected to the torque converter cover 4 via upset rivets 2 in a riveting process. The hub 3 is used to direct fluid to an actuator piston 7 that drives a lock-up clutch 6 and also provides a sealing surface for the actuator piston 7. A damper 9 is also located within the torque converter cover 4 in order to smooth out the torque transferred via the ICE to a transmission output hub 10 that is adapted to be engaged via an input shaft of the transmission gearbox XMSN.

As noted in the Background above, in this prior art arrangement there is a high risk of damaging or cracking the hub 3 during the riveting process.

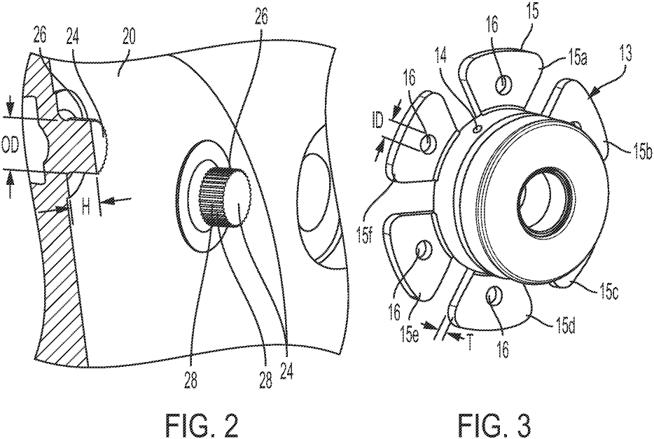

Referring now the FIGS. 2-4, a transmission assembly 11 in accordance with the present disclosure is shown that is adapted to be located between an end of a crankshaft and a transmission gear box. The transmission assembly 11 includes a hub 13, shown in detail in FIG. 3, having a fluid path 14 for a lock-up clutch 5, such as shown in FIG. 1. The hub 13 further includes a hub flange 15. The hub 13 can be made of steel or for enhanced weight savings and cost reduction, can be made of a light weight material such as aluminum or a powdered metal.

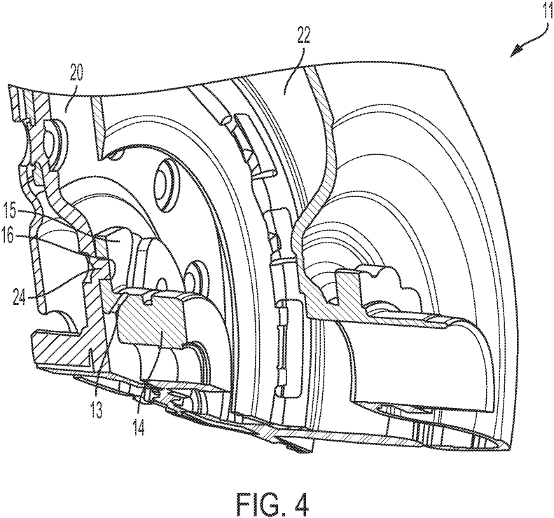

As shown in FIGS. 2 and 4, a torque converter 22 (similar to the torque converter 5 above) having a torque converter cover 20 is provided with extruded studs 24 formed on the torque converter cover 20 in an area adapted to be connected to the hub flange 15. These extruded studs 24 are formed of the material of the torque converter cover 20 during the stamping process and include a circumferential outer surface 26, preferably having a plurality of serrations 28 located thereon. The torque converter cover 20 is preferably stamped from steel sheet metal.

Still with reference to FIGS. 2-4, the hub flange 15 includes holes 16 defined in locations corresponding to the locations of the extruded studs 24. A respective inside diameter ID of each of the holes 16 is smaller than an outside diameter OD of the studs 24. As is shown in FIG. 4, the hub 13 is assembled to the torque converter 20 via the studs 24 engaging in the hole 16 in the hub flange 15 with an interference fit.

Preferably, the extruded studs 24 have a height H that is approximately equal to a thickness T of the hub flange 15. This limits the amount of material that must be moved in order to extrude the studs 24 during the stamping process for the torque converter cover 20.

Referring to FIGS. 1 and 4, the transmission assembly 11 preferably also includes the actuator piston 7 as well as the lock-up clutch 6 located inside the torque converter cover 20 in a similar manner as shown in FIG. 1. Additionally, preferably the damper 9 which is connected to the torque converter turbine 8 of the torque converter 5 is also located within the torque converter cover 20. Further, a transmission output hub 10 is connected to the torque converter turbine 8.

In the present arrangement, the hub 13 is held axially in position against the torque converter cover 20 in the assembled state of the transmission assembly 11 with the gear box by the output hub 10. As the only loads transmitted via the hub 13 are axial loads and any axial movement is limited by the output hub 10, there is no need to have any further axial fixing of the hub 13 to the torque converter cover 20.

Referring to FIG. 3, preferably the hub flange 15 is segmented and includes a plurality of segments 15a-15f, and one of the holes 16 is located in each of these flange segments 15a-15f.

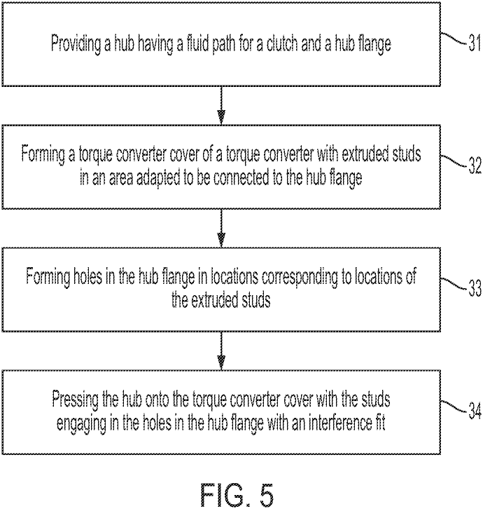

A method of assembling the transmission assembly 11 is also provided and will be explained in connection with FIG. 5, as well as FIGS. 2 - 4. As shown at 31, the hub 13 is provided which has the fluid path 14 for the lock-up clutch 5. As shown at 32, the torque converter cover 20 is formed with extruded studs 24 in an area to be adapted to be connected to the hub flange 15. As noted above, these extruded studs 24 include a circumferential outer surface 26 preferably having a plurality of serrations 28. These serrations 28 are preferably in the form of parallel grooves that extend in an axial direction of the transmission assembly 11.

As shown at 33, holes 16 are formed in the hub flange 15 in locations corresponding to locations of the extruded studs 24.

Finally, as shown at 34, the hub 13 is pressed onto the torque converter 20 with the studs 24 engaged in the holes 16 in the hub flange 15 with an interference fit.

The method can further include assembling the actuator piston 7 as well as the lock-up clutch 6 inside the torque converter cover 20. Here, the hub 13 provides a sealing surface for the actuator piston 7. The method can further incliude installing a torque converter turbine 8 along with a damper 9 connected to the torque converter turbine 8 inside the torque converter cover 20. Further, a transmission output hub 10 is connected to the damper 9, which is riveted to the torque converter turbine 8.

The present transmission assembly 11 is preferably used in connection with a P1 hybrid arrangement and provides enhanced benefits with respect to forming the hub 13 of a light weight material, such as aluminum or a powdered metal, while avoiding potential defects from cracking which could result from following the prior practice of upset riveting to connect the hub 3 to the torque converter cover 4.

Having thus described the presently preferred embodiments in detail, it is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope that is indicated by the appended claims rather than by the foregoing description, and all alternate embodiments and changes to this embodiment which come within the meaning and range of equivalency of said claims are therefore to be embraced therein.

List of Reference Symbols

| ICE | internal combustion engine |
|---|---|
| XMSN | transmission |
| EM | electric motor |
| 1 | crankshaft |
| 2 | rivets |
| 3 | hub |
| 4 | torque converter cover |
| 5 | torque converter |
| 6 | lock-up clutch |
| 7 | actuator piston |
| 8 | turbine |
| 9 | damper |
| 10 | output hub |
| 11 | transmission assembly |
| 13 | hub |
| 14 | fluid path |
| 15 | hub flange |
| 15a-f | segments |
| 16 | holes |
| 20 | torque converter cover |
| 22 | torque converter |
| 24 | extruded studs |
| 26 | circumferential outer surface |
| 28 | serrations |

1. A method of assembling a transmission assembly, comprising:
providing a hub having a fluid path for a clutch and a hub flange;
forming a torque converter cover of a torque converter with a plurality of extruded studs in an area adapted to be connected to the hub flange, each of the plurality of extruded studs including a circumferential outer surface having a plurality of serrations extending in an axial direction parallel to an axis of each of the plurality of extruded studs, each of the plurality of serrations extending to an outer end of the circumferential outer surface;
forming a plurality of holes in the hub flange in locations corresponding to locations of the plurality of extruded studs, a respective inside diameter of each of the plurality of holes being smaller than an outside diameter of each of the plurality of extruded studs; and
pressing the hub onto the torque converter cover with the plurality of extruded studs engaging in the plurality of holes in the hub flange with an interference fit.

2. The method of claim 1, wherein each of the plurality of extruded studs have a height that is equal to a thickness of the hub flange.

3. (canceled)

4. The method of claim 1, further comprising installing an actuator piston and a lock-up clutch inside the torque converter cover.

5. The method of claim 4, further comprising installing a torque converter turbine and a damper connected to the torque converter turbine inside the torque converter cover, and a transmission output hub connected to the damper.

6. The method of claim 5, wherein the transmission output hub holds the hub axially against the torque converter cover in an assembled state of the transmission with a gearbox.

7. A transmission assembly configured to be located between an end of a crankshaft and a transmission gear box, the transmission assembly comprising:
a hub having a fluid path for a clutch and a hub flange;
a torque converter having a torque converter cover;
a plurality of extruded studs formed on the torque converter cover in an area adapted to be connected to the hub flange, each of the plurality of extruded studs including a circumferential outer surface having a plurality of serrations extending in an axial direction parallel to an axis of each of the plurality of extruded studs, each of the plurality of serrations extending to an outer end of the circumferential outer surface;
the hub flange including a plurality of holes defined in locations corresponding to locations of the plurality of extruded studs, a respective inside diameter of each of the plurality of holes being smaller than an outside diameter of each of the plurality of extruded studs, wherein the hub flange is segmented into individual non-connected segments, and one of the plurality of holes is located in each flange segment; and
wherein the hub is assembled to the torque converter cover via the plurality of extruded studs engaging in the plurality of holes in the hub flange with an interference fit.

8. The transmission assembly of claim 7, wherein each of the plurality of extruded studs have a height that is equal to a thickness of the hub flange.

9. (canceled)

10. The transmission assembly of claim 7, wherein the hub is formed of powdered metal or aluminum.

11. The transmission assembly of claim 7, further comprising an actuator piston and a lock-up clutch inside the torque converter cover.

12. The transmission assembly of claim 11, further comprising a damper connected to a torque converter turbine of the torque converter, and a transmission output hub connected to the torque converter turbine.

13. The transmission assembly of claim 12, wherein the output hub is configured to hold the hub axially against the torque converter cover.

14. (canceled)

15. A transmission assembly configured to be located between an end of a crankshaft and a transmission gear box, the transmission assembly comprising:
a hub having a fluid path for a clutch and a hub flange;
a torque converter having a torque converter cover;
a plurality of extruded studs formed on the torque converter cover in an area adapted to be connected to the hub flange, wherein each of the plurality of extruded studs includes a circumferential outer surface having a plurality of serrations extending in an axial direction parallel to an axis of each of the plurality of extruded studs, each of the plurality of serrations extending to an outer end of the circumferential outer surface;
the hub flange including a plurality of holes defined in locations corresponding to locations of each of the plurality of extruded studs, a respective inside diameter of each of the plurality of holes being smaller than an outside diameter of each of the plurality of extruded studs; and
wherein the hub is assembled to the torque converter cover via the plurality of extruded studs engaging in the plurality of holes in the hub flange with an interference fit.

16. The transmission assembly of claim 15, wherein a height of each of the plurality of extruded studs is equal to a thickness of the hub flange.

17. (canceled)

18. The transmission assembly of claim 15, further comprising an actuator piston and a lock-up clutch inside the torque converter cover.

19. The transmission assembly of claim 18, further comprising a damper connected to a torque converter turbine of the torque converter, and a transmission output hub connected to the torque converter turbine.

20. The transmission assembly of claim 19, wherein the output hub is configured to hold the hub axially against the torque converter cover.

21. The transmission assembly of claim 15, wherein the hub flange is segmented, and one of the holes is located in each flange segment.

22. The transmission assembly of claim 15, wherein the plurality of serrations of each of the plurality of extruded studs engage with the plurality of holes in the hub flange when the hub is assembled to the torque converter cover.
